(19) United States
(12) Patent Application Publication
(10) Pub. No.: US 2007/0064542 A1
(43) Pub. Date: Mar. 22, 2007

(54) Wristwatch type apparatus

(75) Inventor: Nobuto Fukushima, Nishitokyo-shi (JP)

Correspondence Address: THE WEBB LAW FIRM, P.C., 700 KOPPERS BUILDING, 436 SEVENTH AVENUE, PITTSBURGH, PA, 15219, US

(73) Assignee: Citizen Watch Co., Ltd, Nishitokyo-shi (JP)

(21) Appl. No.: 11/524,975

(22) Filed: Sep. 21, 2006

(30) Foreign Application Priority Data
Sep. 21, 2005 (JP) 2005-273451

(51) Int. Cl. G04B 37/00

(52) U.S. Cl. 368/282

(57) ABSTRACT

The connecting means of the wristwatch type apparatus comprises a first electric contact point, and the connector portion comprises a second electric contact point. The first electric contact point and the second electric contact point are connected to each other by connecting the connector portion to the connecting means. A tongue portion is formed between the connecting means and the human body in such a manner that the connecting means is separated from the human body. By such a configuration, moisture or a fat generated from a human body does not penetrate to the electric contact point, and the wristwatch type apparatus provided with a connecting means having a high reliability can be provided without degrading a design.

### TECHNICAL FIELD

The present invention relates to a wristwatch type apparatus, and more particularly to a wristwatch type apparatus provided with an electric contact point for filling a charging battery incorporated in an apparatus body or an electric contact point for sending information to or receiving information from an external apparatus.

### BACKGROUND ART

In recent years, according to a penetration of the information-oriented society, information to be required has been available by using an electronic apparatus regardless of an indoor place or an outdoor place. As such an electronic apparatus, there are known a personal computer provided with a communication facility, an electronic information terminal such as a personal digital assistance (PDA), and a portable telephone capable of connecting with the internet. Such an electronic apparatus is being miniaturized and lightened due to the utilization environment in which users are usually carrying the electronic apparatus.

Among the electronic information terminals, there is a wristwatch type apparatus as an apparatus that is used while being always worn. The wristwatch type apparatus is provided with a communication facility or an information processing facility in a conventionally known wristwatch, and is capable of sending information to or receiving information from an external apparatus and of displaying or processing the information.

Such a wristwatch type apparatus is provided with a liquid crystal display unit or a central processing unit and requires a large electric power to effectively implement the facilities. Consequently, the wristwatch type apparatus must be provided with a power supply means extremely larger than that of a normal electronic type wristwatch that has only a facility for notifying of time.

While many proposals have been carried out for a power supply means incorporated in a wristwatch type apparatus, a utilization environment in which users utilize the electronic apparatus while wearing it on an arm causes the size of the wristwatch type apparatus to be restricted. Consequently, a large battery cannot be installed as a power supply means, and there is known a method of incorporating a charging means that is supplied with an electric power from the outside in order to store the electric power (for instance, see Japanese Laid-Open Patent Publication No. 2004-289521 (Pages 3 and 4, and FIG. 9)).

The prior art described in Japanese Laid-Open Patent Publication No. 2004-289521 discloses a configuration for charging a secondary battery, which is installed as a power supply means in a wristwatch type apparatus, by using an external apparatus.

The above configuration will be described referring to FIG. 5. FIG. 5 is a drawing that has been redrawn to simplify the description of the prior art disclosed in Japanese Laid-Open Patent Publication No. 2004-289521 without departing from the scope of the prior art.

In FIG. 5, a numeral 200 represents a wristwatch type apparatus, a numeral 201 represents a rear face of the wristwatch type apparatus 200, a numeral 202 represents an electric contact point, a numeral 203 represents a depression involving the electric contact point 202, and a numeral 204 represents a cover portion.

The prior art disclosed in Japanese Laid-Open Patent Publication No. 2004-289521 is provided with a depression 203 on the rear face, which is the side that comes into contact with a human body of a user, and an electric contact point 202 in the depression. In addition, a cover portion 204 is formed in order to cover the electric contact point 202.

The electric contact point 202 is connected to a secondary battery and an electronic circuit (not shown) installed inside the wristwatch type apparatus 200. The wristwatch type apparatus 200 is driven by an electric power charged in the secondary battery. In the case in which an electric power in the secondary battery is lowered, the electric contact point 202 is connected to an external apparatus by using a connecting device (not shown) in order to charge the secondary battery.

The cover portion 204 has a function of protecting the electric contact point 202 when the wristwatch type apparatus 200 is not charged. In the case in which the cover portion 204 is closed toward the rear face 201, the cover portion 204 covers the depression 203 and the electric contact point 202 is shielded from the outside.

Since the electric contact point 202 is connected to a secondary battery or an electronic circuit, in the case in which another electrical apparatus or a metal substance comes into contact with the electric contact point 202, the terminals of the electronic circuit or the secondary battery may be shorted, thereby causing an overflow of an excess current. However, in the case in which charging is not carried out, the cover portion 204 shields the electric contact point 202, thereby preventing such an accident.

### DISCLOSURE OF THE INVENTION

### Problems to be Solved by the Invention

In the prior art disclosed in Japanese Laid-Open Patent Publication No. 2004-289521, the opening and closing operations of the cover portion 204 can protect the electric contact point 202. However, in the case in which a user continuously uses the wristwatch type apparatus 200, there is a problem of the electric contact point 202 that may cause a contact failure.

More specifically, the wristwatch type apparatus 200 is fixed in such a manner that the rear face 201 comes into contact with an arm of a human body of a user. Since a cross section of an arm is not uniform, even in the case in which the rear face 201 is pressed to an arm, the entire surface of the rear face 201 is not in contact with an arm, and the rear face 201 is not completely apart from a human body. That is to say, the entire surface or a part of the cover portion 204 is always in contact with a human body, and the electric contact point 202 is apart from a human body only through the cover portion 204.

In such a utilization environment, moisture or a fat that comes out of a human body penetrates into the depression 203 through a gap between the cover portion 204 and the rear face 201, and reaches and corrodes the electric contact point 202. The cover portion 204 for covering the electric contact point 202 is always closed to the rear face 201 side in the case in which a user is using the wristwatch type apparatus 200. Therefore, once moisture or a fat penetrates into the depression 203, moisture or a fat cannot be easily discharged.

As described above, by the action of moisture or a fat that has penetrated into the depression 203, the surface of the electric contact point 202, which has a conductivity, is corroded, thereby enlarging an electrical resistance and causing a contact failure.

In the prior art disclosed in Japanese Laid-Open Patent Publication No. 2004-289521, there is required a configuration capable of reliably opening and closing the cover portion 204 in such a manner that a connection of the electric contact point 202 with an external apparatus is ensured, the electric contact point 202 is protected, and corrosion is prevented.

In such a configuration in which the cover portion 204 is openable and closable, since the cover portion 204 is always in contact with a human body, the opening and closing structure of the cover portion 204 is easily damaged by a friction or a pressure with a human body. As a result, an effect of the cover portion 204 for shielding the depression 203 from an external environment is decreased, thereby causing corrosion due to a penetration of the above moisture or a fat. In addition, such a damage of the opening and closing structure of the cover portion 204 may deteriorate an appearance and a beauty of the wristwatch type apparatus 200.

To avoid such a problem, it is necessary to take measures such as making the cover portion 204 strong and firm. However, in the case in which such a measure is taken, the configuration of the wristwatch type apparatus 200 is made complicated and a production cost is increased.

Moreover, a wristwatch type apparatus is required to be miniaturized and lightened. However, the complicated opening and closing structure of the cover portion 204 is contrary to the requirement and is not preferable.

To solve the above problems, an object of the present invention is to provide a wristwatch type apparatus resulting in no contact failures even in the case in which an electric contact point is incorporated without sacrificing a design.

### MEANS FOR SOLVING THE PROBLEMS

The present invention has been made in order to solve the problems and to achieve the objects in the prior art described above.

A wristwatch type apparatus of the present invention is characterized by being provided with an apparatus body, a connecting means formed in the apparatus body for connecting with another apparatus, and a band member; and comprising a connector portion at an edge of the band member;

wherein the band member becomes ring-shaped by detachably connecting the connector portion to the connecting means formed in the apparatus body and can be fixed to an worn portion of a human body.

Moreover, a wristwatch type apparatus of the present invention is characterized in that the connecting means comprises a first electric contact point that is connected to an electronic circuit incorporated in the apparatus body,

the band member comprises a conductive wire, and

the connector portion comprises a second electric contact point that is connected to the conductive wire;

wherein the first electric contact point and the second electric contact point are connected to each other by connecting the connector portion to the connecting means.

Furthermore, a wristwatch type apparatus of the present invention is characterized by further comprising a tongue portion between the connecting means and the human body, thereby preventing the worn portion of the human body and the first electric contact point from directly coming into contact with each other.

Still further, a wristwatch type apparatus of the present invention is characterized in that the tongue portion is formed on the side of the connecting means.

Still further, a wristwatch type apparatus of the present invention is characterized in that the tongue portion is formed on the side of the connector portion.

Still further, a wristwatch type apparatus of the present invention is characterized by further comprising a connector portion at another edge of the band member.

Still further, a wristwatch type apparatus of the present invention is characterized in that a connector portion formed in another apparatus can be connected to the connecting means formed in the apparatus body in the state in which a connection between the connector portion of the band member and the connecting means formed in the apparatus body is released.

Still further, a wristwatch type apparatus of the present invention is characterized in that a connector portion formed in another apparatus can be connected to the connector portion formed in the band member in the state in which a connection between the connector portion of the band member and the connecting means formed in the apparatus body is released.

### EFFECT OF THE INVENTION

The wristwatch type apparatus of the present invention is provided with a connector portion formed at an edge of the band member, and the band member enables the wristwatch type apparatus to be fixed to a worn portion of a human body by detachably connecting the connector portion to the connecting means formed in the apparatus body.

In this fixing state, the band member is ring-shaped and can be fixed in such a manner that the band member is wound around an arm of a human body.

The connecting means of the wristwatch type apparatus comprises a first electric contact point, and the connector portion comprises a second electric contact point. The first electric contact point and the second electric contact point are connected to each other by connecting the connector portion of the band member to the connecting means formed in the apparatus body.

Moreover, the band member is provided with a conductive wire, and a signal can be transmitted between the conductive wire and an electronic circuit incorporated in the apparatus body by a connection between a first electric contact point that is connected to the electronic circuit incorporated in the apparatus body and a second electric contact point that is connected to the conductive wire.

Furthermore, a tongue portion is formed between the connecting means and a human body, and can prevent moisture or a fat generated from a human body from penetrating into the connector portion or the connecting means. Consequently, the first electric contact point and the second electric contact point can be prevented from being corroded.

Still further, a connector portion formed in another apparatus can be connected to the connecting means formed in the apparatus body in the state in which a connection between the connector portion of the band member and the connecting means formed in the apparatus body is released, and an electric signal for charging and an electric signal such as electronic information, etc. from an external apparatus can be input to the apparatus body through the connecting means formed in the apparatus body.

Still further, a connector portion formed in another apparatus can be connected to the connector portion formed in the band member in the state in which a connection between the connector portion of the band member and the connecting means formed in the apparatus body is released, and an electric signal for charging and an electric signal such as electronic information, etc. from an external apparatus can be input to the apparatus body through the connector portion formed in the band member and the conductive wire incorporated in the band member.

The wristwatch type apparatus of the present invention enables an electric contact point having a high reliability to be formed in the wristwatch type apparatus without degrading a design as an apparatus to be worn on an arm and without an enlargement of an outline which becomes a fault on use. In addition, the present invention can provide a wristwatch type apparatus having many facilities.

### BRIEF DESCRIPTION OF THE DRAWINGS

FIG. 1 is a perspective view illustrating a wristwatch type apparatus of the present invention.

FIG. 2 is a schematic view illustrating a detailed connecting portion of an apparatus body and a band in a wristwatch type apparatus of the present invention.

FIG. 3 is a schematic view illustrating another detailed embodiment of a connecting portion of an apparatus body and a band in a wristwatch type apparatus of the present invention.

FIG. 4 is a perspective view illustrating an embodiment for connecting a wristwatch type apparatus of the present invention with an external apparatus.

FIG. 5 is a perspective view illustrating a prior art.

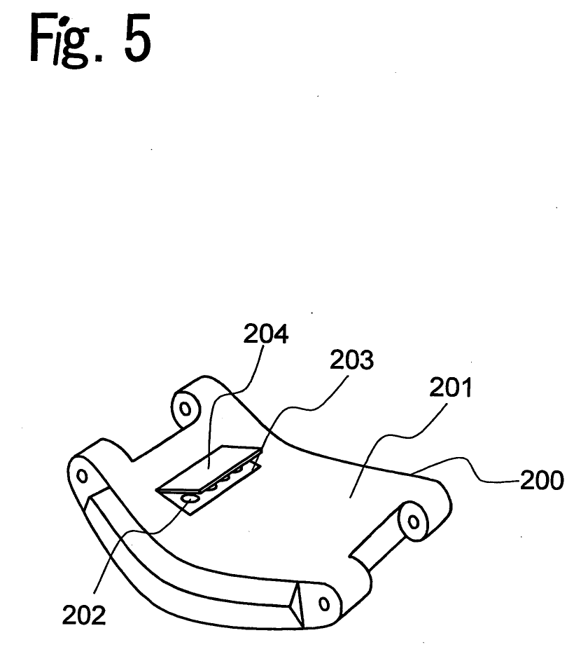

### BEST MODE OF CARRYING OUT THE INVENTION

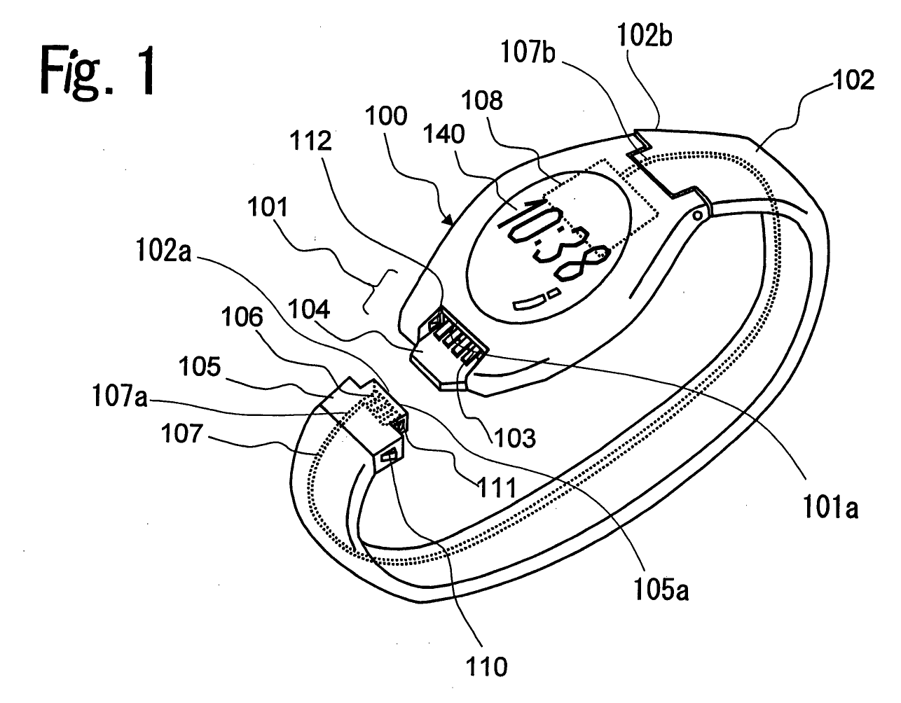

An embodiment (example) of the present invention will be described below in detail with reference to the drawings.

[Description of the Configuration of a Wristwatch Type Apparatus of the Present Invention: FIG. 1]

FIG. 1 is a perspective view illustrating a wristwatch type apparatus of the present invention.

In FIG. 1, a numeral 100 represents an apparatus body of a wristwatch type apparatus. In the present embodiment, the apparatus body 100 of the wristwatch type apparatus is almost wristwatch-shaped.

The apparatus body 100 of the wristwatch type apparatus is provided with a connecting means 101 in a direction of six o'clock of the apparatus body 100 in the case in which the wristwatch type apparatus is regarded as a pointer type wristwatch.

The connecting means 101 is provided with a first electric contact point 103, which is exposed in an opening portion 101a, and a tongue portion 104 that is almost tongue-shaped on the rear face side of the first electric contact point 103, that is, on the side that comes into contact with a wrist or the like of a human body.

On the other hand, a connector portion 105 is formed at an edge 102a of a band member 102 on the side facing the connecting means 101 of the apparatus body 100. A protruded engaging portion 105a, of which the tip portion is shaped complementarily with the opening portion 101a, is formed in the connector portion 105.

As shown by dotted lines in FIG. 1, a second electric contact point 106 is formed in the protruded engaging portion 105a to be electrically connected to the first electric contact point 103 in the connecting means 101 of the apparatus body 100.

As shown by dotted lines in FIG. 1, in the band member 102, there is formed a conductive wire 107 of which an edge 107a is connected to the second electric contact point 106 in the band member 102. The conductive wire 107 is formed in an extending manner to another edge portion 102b of the band member 102 in a longitudinal direction of the band member 102.

In the case in which the wristwatch type apparatus is regarded as a pointer type wristwatch, in a direction of twelve o'clock of the apparatus body 100, another edge portion 102b of the band member 102 is detachably locked by a locking pin. By such a configuration, an electronic circuit 108 incorporated in the apparatus body 100 is electrically connected to another edge portion 107b of the conductive wire 107.

Moreover, a push button 110 is formed on the both edge portions in the transverse direction of a base edge portion of the protruded engaging portion 105a formed at the edge 102a of the band member 102. By pressing the push button 110, a fitting claw 111, which is formed on the both edge portions in the transverse direction of the protruded engaging portion 105a in order to being energized in a protruding direction, can be moved in a retracting direction.

On the other hand, a fitting hole 112, into which the fitting claw 111 is fitted, is formed on an inside wall 115 in the opening portion 101a of the connecting means 101 of the apparatus body 100.

By such a configuration, in the case in which the wristwatch type apparatus is worn on a wrist of a human body, as shown by the arrow in FIG. 1, by attaching the protruded engaging portion 105a of the connector portion 105 at the edge 102a of the band member 102 into the opening portion 101a of the connecting means 101 of the apparatus body 100, the band member 102 is made loop-shaped around a wrist, thereby fixing the wristwatch type apparatus to the wrist.

In this state, the first electric contact point 103 incorporated in the connecting means 101 is electrically connected to the second electric contact point 106 incorporated in the connector portion 105. In addition, the fitting claw 111 energized in a protruding direction is fitted and locked into the fitting hole 112 formed in the opening portion 101a of the connecting means 101 of the apparatus body 100, thereby preventing slipping off.

On the other hand, in the case in which the wristwatch type apparatus is detached from a wrist of a human body, by pressing the push button 110, the fitting claw 111 is moved in a retracting direction to release an engagement of the fitting claw 111 with the fitting hole 112. As a result, as shown by the arrow in FIG. 1, a connecting state of the protruded engaging portion 105a of the connector portion 105 of the band member 102 with the connecting means 101 of the apparatus body 100 can be released.

In FIG. 1, a numeral 140 represents a display means formed on the upper surface of the apparatus body 100.

The band member 102 is made of, for instance, a resin material or a metal having a flexibility of a certain degree. The band member 102 can be previously shaped like a circular arc, and can have a configuration in which a metal exterior package is attached to a resin material. The metal exterior package can be made of a shape memory alloy.

The conductive wire 107 is formed in the band member 102 to connect an edge thereof with the electronic circuit 108 incorporated in the apparatus body 100 and another edge thereof with the second electric contact point 106 incorporated in the connector portion 105.

The conductive wire 107 formed in the band member 102 can be, for instance, an antenna plate. The electronic circuit 108 incorporated in the apparatus body 100 is, in this case, a receiving circuit for receiving an external signal transmitted to the conductive wire 107.

In the case in which the band member 102 is made of a metal, the conductive wire 107 is insulated from the exterior package made of a metal.

While only one conductive wire 107 is shown in the embodiment illustrated in FIG. 1 to make an explanation easy, wires of the required number can be incorporated in practice. For instance, wires required for the wristwatch type apparatus can be involved such as a signal line, a power supply line, and a GND line for a shield. Similarly, while the embodiment shown in FIG. 1 illustrates four first electric contact points 103 and four second electric contact points 106, the present invention is not restricted to the embodiment, and electric contact points of the required number can also be formed.

Moreover, the shapes of the wires, the electric contact points, and the connecting means 101 can conform to a connecting means of a known specification, for instance, the universal serial bus (USB) interface. As described above, by making the connecting configuration of the wristwatch type apparatus of the present invention compatible with that used in other apparatuses, the wristwatch type apparatus of the present invention can be connected to many other apparatuses.

In the case in which the wristwatch type apparatus is regarded as a pointer type wristwatch, the band member 102 is locked in a direction of twelve o'clock of the apparatus body 100, and the connecting means 101 is formed in a direction of six o'clock of the apparatus body 100.

The connector portion 105 is fitted into the connecting means 101 from the direction of six o'clock, and the first electric contact point 103 incorporated in the connecting means 101 is connected to the second electric contact point 106 incorporated in the band member 102.

In such a fitting state of the connector portion 105 into the connecting means 101, the band member 102 is ring-shaped and fixed to a human body (an arm in this case) of a user. In the case in which the conductive wire 107 is an antenna plate, the antenna plate forms a closed loop in this state.

As for a wristwatch type apparatus such as a so-called radio wristwatch for modifying time by receiving radio waves such as long waves and a wristwatch type pager for receiving information using radio waves, an apparatus in which an antenna plate is enclosed in a band member is currently available in the market place.

Such a conventional wristwatch type apparatus has a configuration in which two antenna plates incorporated in band members on the twelve o'clock side and the six o'clock side, respectively, are connected to each other by a buckle or the like formed in the band members. Without utilizing such a configuration, the conventional wristwatch type apparatus cannot be fixed to an arm of a user.

Such a configuration allows moisture or a fat generated from a human body to penetrate into a connecting portion between antenna plates at the buckle portion in many cases. However, the wristwatch type apparatus of the present invention requires no buckle, thereby preventing an antenna plate from being deteriorated.

A connection between the connector portion 105 and the connecting means 101 is carried out by fitting the fitting claw 111 into the fitting hole 112, and the connection is released by pressing the push button 110. The details are described later.

The tongue portion 104 is disposed between a human body and the connecting means 101 that is a connecting portion of the band member 102 and the apparatus body 100. The existence of the tongue portion 104 can prevent the first electric contact point 103 from directly coming into contact with a human body, thereby preventing the corrosion of the contact point due to a contact with moisture or a fat generated from a human body.

The tongue portion 104 can be integrated with the apparatus body 100. Of course, the tongue portion 104 can also be formed separately and connected to the apparatus body 100. In the case in which the tongue portion 104 is integrated with the apparatus body 100, for instance, a rear cover of the apparatus body 100 can be extended to form the tongue portion. Anyway, it is necessary that the flat surface of the tongue portion 104 is larger than that of the first electric contact point 103 and the tongue portion 104 is disposed between the electric contact point and a human body. This is the characteristic point of the wristwatch type apparatus of the present invention.

The tongue portion 104 is out of sight and invisible from the upper surface of the apparatus body 100 in the state in which the connector portion 105 is fitted into the connecting means 101. By such a configuration, the first electric contact point 103 can be protected without degrading a design of the apparatus body 100.

While the tongue portion 104 is formed on the side of the apparatus body 100 in the present embodiment, for instance, the tongue portion 104 can also be protruded from the protruded engaging portion 105a of the connector portion 105 of the band member 102 toward the side of the apparatus body 100.

Moreover, in the embodiment illustrated in FIG. 1, in the case in which the wristwatch type apparatus is regarded as a pointer type wristwatch, the connecting means 101 is formed in a direction of six o'clock of the apparatus body 100, and the connector portion 105 is formed at the edge 102a of the band member 102 on the side facing the connecting means 101 of the apparatus body 100.

However, the connecting means 101 can also be formed in a direction of twelve o'clock of the apparatus body 100, and the connector portion 105 can be formed at the other edge 102b of the band member 102 on the side facing the connecting means 101 of the apparatus body 100. Furthermore, the connecting means 101 can also be formed in both directions of six o'clock and twelve o'clock of the apparatus body 100, and the connector portions 105 can be formed at the edge 102a and the other edge 102b of the band member 102 on the sides facing the connecting means 101 of the apparatus body 100.

The display means 140 is a means for displaying information of the apparatus body 100 and can display the operation results of the incorporated electronic circuit 108 and information received from an external apparatus. Such operation results and information can be displayed on the display area of the display means 140 by using images, characters, icons (pictographs) or the like.

The apparatus body 100 has a clocking means although this is not shown in the figure, and time can be displayed on the display means 140 by using information sent from the clocking means. In the embodiment illustrated in FIG. 1, numerals indicating thirty-eight minutes past ten are displayed.

As the display means 140, it is preferable to use a liquid crystal display apparatus and so on. The reason is that a liquid crystal display apparatus is suitable for low current consumption. As a liquid crystal display apparatus, a liquid crystal display apparatus having a memory function can also be used. For instance, a ferroelectric liquid crystal display apparatus can be used. The ferroelectric liquid crystal display apparatus uses a ferroelectric liquid crystal having a spontaneous polarization, in which the orientation of the spontaneous polarization can be modified by applying an electric field thereto and an inclination of a liquid crystal molecule can be modified. Consequently, each state can be maintained even in the case in which an electric field is cut off. Since the memory function is involved, an electric power for maintaining a display is not required, thereby extremely decreasing the power consumption as the display apparatus.

Of course, for the display means 140, a pointer type analog clock and a liquid crystal display apparatus can also be used.

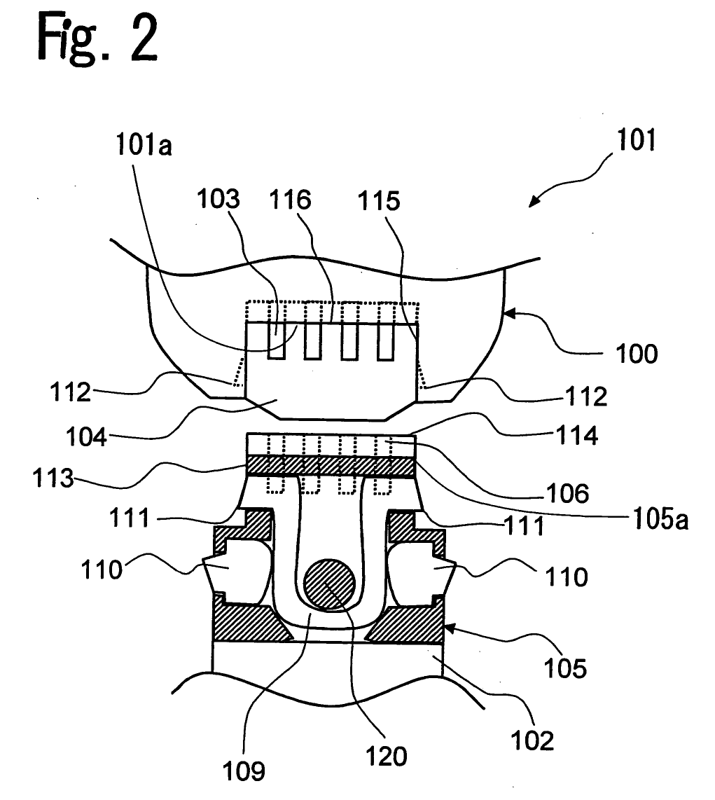

In the apparatus body 100 shown in FIG. 1, switches and buttons required for operating the wristwatch type apparatus are omitted to make an explanation easy.

[Description of the Connecting Means: FIG. 2]

Next, the following describes a fitting state of the connector portion 105 into the connecting means 101 in the wristwatch type apparatus of the present invention. FIG. 2 is an enlarged view of a section around the connecting means 101, and the connector portion 105 is shown in such a manner that its internal configuration is visible to make an explanation easy.

In FIG. 2, a numeral 109 represents a fitting spring, a numeral 113 represents a side face of the connector portion 105, a numeral 114 represents a front face of the connector portion 105, a numeral 115 represents an inside wall of the connecting means 101, a numeral 116 represents a back face of the connecting means 101, and a numeral 120 represents a spring guide.

Here, elements equivalent to those illustrated in FIG. 1 are numerically numbered similarly and the detailed descriptions of the equivalent elements are omitted.

As shown in FIG. 2, the connector portion 105 is provided with a push button 110 and a fitting claw 111. The fitting claw 111 is disposed at the both edges of the fitting spring 109, which is made of an elastic material and almost U-shaped, and is energized in a protruding direction from the side face 113 of the connector portion 105.

A slope is formed on the fitting claw 111, which is formed to be wedge-shaped, in such a manner that a width of the fitting claw 111 becomes narrower toward the front face 114 of the connector portion 105. In the case in which the push button 110 is pressed, since the base edge portion of the fitting spring 109 is pressed in a forced direction, the fitting claw 111 disposed at the both edges of the fitting spring 109 is retracted up to the side face 113 or inside the side face 113. The fitting spring 109 is positioned by the spring guide 120, and is not dislocated even when being pressed by the push button 110.

The following describes the case in which the band member 102 is connected to the apparatus body 100.

The connector portion 105 of the band member 102 is forced into the connecting means 101 of the apparatus body 100. The side face 113 of the protruded engaging portion 105a in the connector portion 105 is abutted to and guided by the inside wall 115 of the connecting means 101.

Since the fitting claw 111 is provided with a slope, the fitting claw 111 is energized in the direction of the side face 113 (in the retracted direction) due to the slope in the case in which the fitting claw 111 is abutted to the inside wall 115. By this force, the fitting claw 111 is forced up to the plane almost equivalent to the side face 113 against the energizing power of the fitting spring 109.

In the case in which the band member 102 is further forced to the apparatus body 100, the connector portion 105 is stopped at the position in which the front face 114 of the connector portion 105 is abutted to the back face 116 of the connecting means 101. At this position, the fitting claw 111 is corresponded to the fitting hole 112, and the tip of the fitting claw 111 is not pressed any more by the inside wall 115. Consequently, the energizing power is recovered and the fitting claw 111 is energized in a protruding direction. As a result, the tip of the fitting claw 111 is fitted into the fitting hole 112 having a shape almost equivalent to that of the fitting claw 111.

In this state, the first electric contact point 103 incorporated in the connecting means 101 is connected to the second electric contact point 106 incorporated in the connector portion 105.

Moreover, in this state, the wedge-shaped fitting claw 111 is fitted into the wedge-shaped fitting hole 112. Therefore, even in the case in which a force is applied to the band member 102 in the direction for drawing the band member 102 from the apparatus body 100, the band member 102 is not detached from the apparatus body 100 due to an action of a wedge.

In the case in which the band member 102 is released (detached) from the apparatus body 100, the push button 110 is pressed and the band member 102 is pulled in the direction for separating the band member 102 and the apparatus body 100.

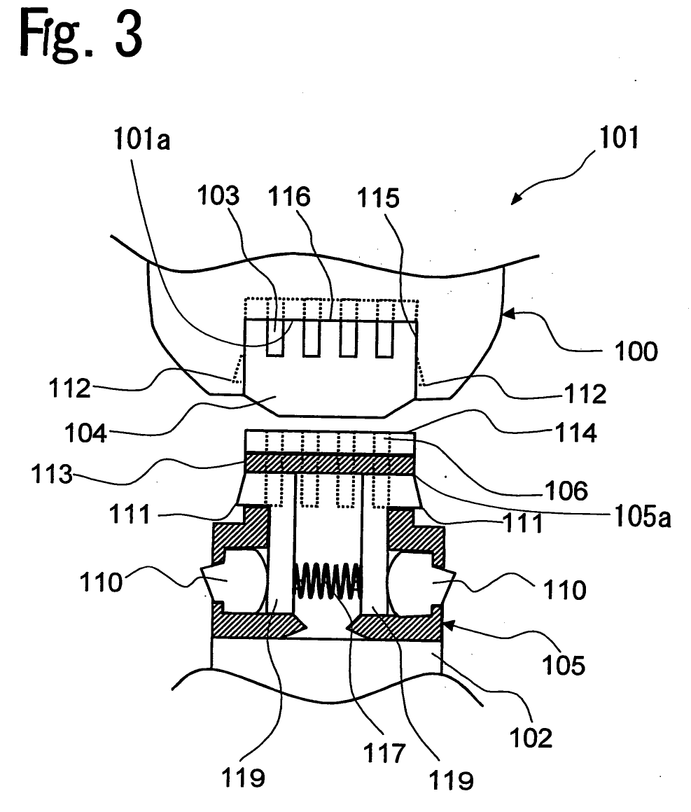

More specifically, by pressing the push button 110, since the base edge portion of the fitting spring 109 is pressed in a forced direction, the fitting claw 111 disposed at the both edges of the fitting spring 109 is retracted up to the side face 113 of the connector portion 105 or inside the side face 113. As a result, the fitting of the fitting claw 111 into the fitting hole 112 is released, and the band member 102 can be easily detached.

[Description of the Connecting Means: FIG. 3]

The configuration of the connector portion 105 is not restricted to the above described configuration. FIG. 3 is a view for illustrating a configuration different from that shown in FIG. 2 and for illustrating an embodiment in which a coil spring 117 is used in place of the fitting spring 109 shown in FIG. 2 and which has a facility equivalent to that of the connector portion 105 shown in FIG. 2.

The fitting claw 111 is disposed at the both edges of a pair of fitting members 119 which are almost L-shaped, and is energized in a protruding direction from the side face 113 of the connector portion 105 by the coil spring 117 disposed between the base edge portions of a pair of fitting members 119.

Here, elements equivalent to those illustrated in FIG. 1 are numerically numbered similarly and the detailed descriptions of the equivalent elements are omitted.

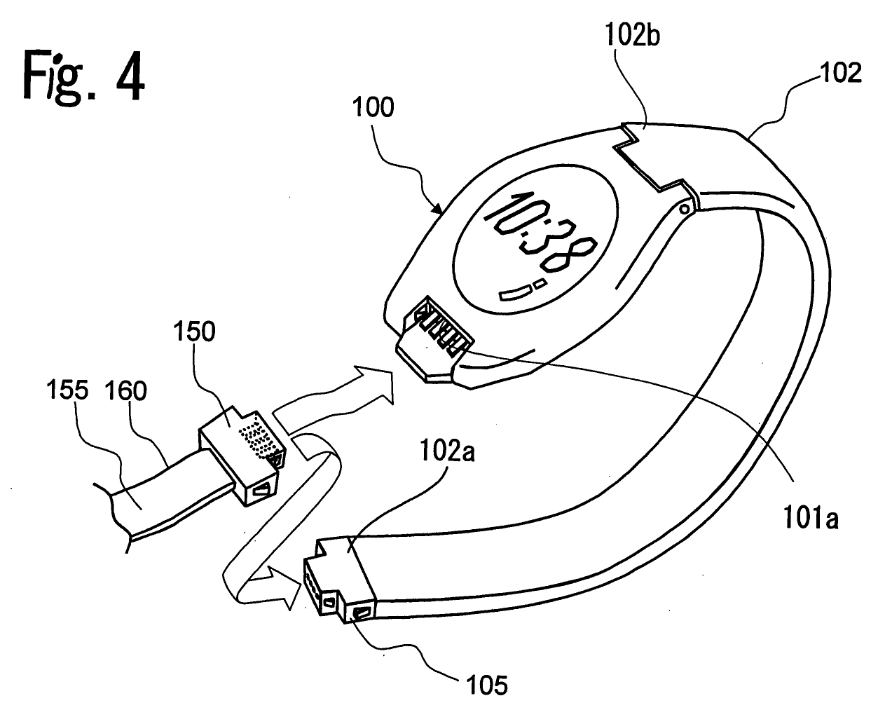

As shown in FIG. 3, in the case in which the push button 110 is pressed, the fitting claw 111 is retracted up to the side face 113 or inside the side face 113 against the energizing power of the coil spring 117. The case in which the band member 102 is connected to or released from the apparatus body 100 is similar to that of the embodiment illustrated in FIG. 2, and the detailed descriptions of the case are omitted.

[Description of the Connection with an External Apparatus: FIG. 4]

While the wristwatch type apparatus of the present invention can receive an external signal through the conductive wire 107 by using radio waves, an external signal can also be directly input to the apparatus body 100.

FIG. 4 is a view for illustrating an example for connecting the apparatus body 100 with a connecting device for connecting with an external apparatus such as a personal computer.

In FIG. 4, a numeral 150 represents an external connector, a numeral 155 represents a cable, and a numeral 160 represents a connecting device with an external apparatus.

In the case in which the connecting device 160 with an external apparatus is connected to the apparatus body 100, the connecting device 160 can be connected to any of the connecting means 101 and the connector portion 105. The external connector 150 can be prepared according to a connecting shape of the wristwatch type apparatus of the present invention.

More specifically, for the sake of convenience for an explanation, the shape of the external connector 150 is matched to the connecting shape of the connecting means 101 in FIG. 4. However, in the case in which the external connector 150 is connected to the connector portion 105, the shape of the external connector 150 can be matched to the connecting shape of the connector portion 105.

The external connector 150 of the connecting device 160 with an external apparatus is connected to the apparatus body 100, and an external signal can be transmitted through the first electric contact point 103 or the second electric contact point 106.

The external signal is, for instance, an electric signal for charging. By receiving such an electric signal, an electric power can be stored in a charging circuit or a secondary battery (not shown) incorporated in the apparatus body 100.

Of course, an external signal is not restricted to the above signal. For instance, in the case in which an external apparatus is a personal computer, data such as electronic information created by such a personal computer can be sent to or received from the apparatus body 100.

Moreover, for the wristwatch type apparatus of the present invention, the connecting means 101 incorporated in the apparatus body 100 and the connector portion 105 incorporated in the band member 102 can be connected to different external apparatuses, respectively.

For instance, as shown in FIG. 4 illustrating an example, the connecting device 160 with an external apparatus is connected to the connecting means 101, and a connecting device with another external apparatus (not shown) is connected to the connector portion 105.

By the above configuration, for instance, the connecting means 101 side can be used for sending and receiving information with the external apparatus, and the connector portion 105 side can be used for receiving a voltage signal for charging from the external apparatus.

Since two different connecting elements can be connected to different external apparatuses, respectively, time in relation to sending or receiving of information or a signal can be shortened. That is to say, while the apparatus body 100 is charged, information can be obtained.

In a fitting state of the connector portion 105 into the connecting means 101, the band member 102 is ring-shaped. On the other hand, even in the case in which an external connecting device is connected to the connecting means 101, the wristwatch type apparatus of the present invention can be prevented from slipping off from a human body of a user by maintaining a ring shape of the band member 102 to a certain degree. More specifically, the wristwatch type apparatus of the present invention can be connected to an external apparatus while being worn on a human body of a user, and does not have a troublesomeness in which the wristwatch type apparatus must be detached from a human body to be connected to an external apparatus. This point is also a characteristic of the wristwatch type apparatus of the present invention.

As cleared by the above descriptions, the wristwatch type apparatus of the present invention can shield a penetration of moisture or a fat generated from a human body into the connecting means 101 by the tongue portion 104 incorporated in the connecting means 101. As a result, an electric contact point incorporated in the connecting means 101, the connector portion 105, or the connecting device 160 with an external apparatus can be protected.

Moreover, a wear on a human body or a connection with the connecting device of an external apparatus for the wristwatch type apparatus of the present invention involves a connection and a release of the connecting means 101 and the connector portion 105. Consequently, even if moisture or a fat generated from a human body penetrates into the connecting means 101 over the tongue portion 104, the connection and release can prevent moisture or a fat from being kept in one section and prevent the first electric contact point 103 and the second electric contact point 106 from being corroded.

The wristwatch type apparatus of the present invention enables the wristwatch type apparatus and the band member to be connected to each other without degrading a design as an apparatus to be worn on an arm and without being influenced by moisture or a fat generated from a human body. Consequently, the wristwatch type apparatus of the present invention can be applied to an electronic apparatus that is always worn on a human body. In particular, the wristwatch type apparatus of the present invention is suitable for a wristwatch type compact electronic apparatus, a radio receiving type wristwatch, and a wristwatch type pager.

While the preferred embodiments of the present invention have been described above, the present invention is not restricted to the embodiments. For example, while the push button 110 type was used in the embodiments described above, the slide button type can also be used. In addition, while the wristwatch type apparatus was explained in the embodiments described above, the present invention can also be applied to a wearing type apparatus for being worn on a human body such as a finger, an upper arm, a leg, and a stomach, except for an arm, and various changes can be thus made without departing from the scope of the present invention.

1. A wristwatch type apparatus provided with an apparatus body, a connecting means formed in the apparatus body for connecting with another apparatus, and a band member; comprising
a connector portion at an edge of the band member;
wherein the band member becomes ring-shaped by detachably connecting the connector portion to the connecting means formed in the apparatus body and can be fixed to an worn portion of a human body.

2. A wristwatch type apparatus as defined in claim 1, wherein
the connecting means comprises a first electric contact point that is connected to an electronic circuit incorporated in the apparatus body,
the band member comprises a conductive wire, and
the connector portion comprises a second electric contact point that is connected to the conductive wire;
wherein the first electric contact point and the second electric contact point are connected to each other by connecting the connector portion to the connecting means.

3. A wristwatch type apparatus as defined in claim 1, further comprising a tongue portion between the connecting means and the human body, thereby preventing the worn portion of the human body and the first electric contact point from directly coming into contact with each other.

4. A wristwatch type apparatus as defined in claim 3, wherein the tongue portion is formed on the side of the connecting means.

5. A wristwatch type apparatus as defined in claim 3, wherein the tongue portion is formed on the side of the connector portion.

6. A wristwatch type apparatus as defined in claim 1, further comprising a connector portion at another edge of the band member.

7. A wristwatch type apparatus as defined in claim 1, wherein a connector portion formed in another apparatus can be connected to the connecting means formed in the apparatus body in the state in which a connection between the connector portion of the band member and the connecting means formed in the apparatus body is released.

8. A wristwatch type apparatus as defined in claim 1, wherein a connector portion formed in another apparatus can be connected to the connector portion formed in the band member in the state in which a connection between the connector portion of the band member and the connecting means formed in the apparatus body is released.

9. A wristwatch type apparatus as defined in claim 2, further comprising a tongue portion between the connecting means and the human body, thereby preventing the worn portion of the human body and the first electric contact point from directly coming into contact with each other.

10. A wristwatch type apparatus as defined in claim 9, wherein the tongue portion is formed on the side of the connecting means.

11. A wristwatch type apparatus as defined in claim 9, wherein the tongue portion is formed on the side of the connector portion.

12. A wristwatch type apparatus as defined in claim 2, further comprising a connector portion at another edge of the band member.

13. A wristwatch type apparatus as defined in claim 2, wherein a connector portion formed in another apparatus can be connected to the connecting means formed in the apparatus body in the state in which a connection between the connector portion of the band member and the connecting means formed in the apparatus body is released.

14. A wristwatch type apparatus as defined in claim 2, wherein a connector portion formed in another apparatus can be connected to the connector portion formed in the band member in the state in which a connection between the connector portion of the band member and the connecting means formed in the apparatus body is released.
